(19) United States
(12) Patent Application Publication
(10) Pub. No.: US 2004/0116267 A1
(43) Pub. Date: Jun. 17, 2004

(54) Packaging with a shell closing system and production method therefor

(76) Inventors: Stephane Mathieu, Fluy (FR); Jacques Thomasset, Neuvecelle (FR)

Correspondence Address: Darin J Gibby, Townsend & Townsend & Crew, 8th Floor, Two Embarcadero Center, San Francisco, CA, 94111, US

(21) Appl. No.: 10/471,518

(22) PCT Filed: Mar. 11, 2002
(86) PCT No.: PCT/FR02/00860

(30) Foreign Application Priority Data
Mar. 13, 2001 (FR) 01 03 395

(51) Int. Cl. B31B 1/90

(52) U.S. Cl. 493/394

(57) ABSTRACT

The invention relates to a package (1) comprising a sealing device (2). Said sealing device consists of a fixed concave shell (3) and a moveable shell (4) which is articulated to said fixed shell (3) by means of pivots (5, 6). The moveable shell is provided with flexion inversion means (7, 8). The invention also relates to a method for producing one such package. Such a package can be used, for example, to store foodstuffs.

The invention relates to a closing system, adapted to sachet-type packagings, in particular made of plastic. These packagings or sachets can be “Doypack” or so-called “three-weld” sachets.

A number of plastic packagings or sachets are already known, which may or may not be provided with valves.

GB-A-826 784 discloses a sachet which is obtained by successive folding of a plastic film. This film is folded the first time along a straight line carrying a central orifice, two “V”-shaped welding zones are applied, then the film is folded back on itself. The three free sides are welded, as well as part of the fourth side carrying the gusset with the “V”-shaped welds. The presence of the opening at the base of the gusset, as well as the presence of the two “V”-shaped welds and the partial weld on the side of the opening, is claimed to allow correct functioning of the valve formed by the central orifice.

FR-A-2 711 115 discloses an inflatable sachet provided with a valve. This sachet is obtained by forming two parallel welds in a film folded back on itself, which is then again folded back on itself, in a fashion similar to that of GB-A-826 781. However, in this case, the film which is doubly folded back on itself is welded in order to leave the folded back edges of the film accessible from the outside.

However, the above systems have several drawbacks. They are complex and require a complex folding device. Opening them is moreover not very practical for the user.

The invention makes it possible to remedy the disadvantages of the systems of the prior art. The invention consequently provides a packaging comprising a closing device allowing easy and unlimited opening. Thus, the invention provides a packaging comprising a closing device, the closing device comprising a fixed shell and a moveable shell articulated to the fixed shell via pivots, the moveable shell having flexion inversion means formed by at least one protuberance of the moveable shell beyond a pivot.

According to one embodiment, the moveable shell comprises two rigid articulated parts and the fixed part is flexible.

According to another embodiment, the fixed shell and the moveable shell are placed facing one another.

According to another embodiment, the fixed shell and the moveable shell each have a closing face, said closing faces being displaced. According to one embodiment, the fixed shell is concave. According to another embodiment, the fixed shell is curved. According to yet another embodiment, the fixed shell is formed from an angular cylinder section.

According to one embodiment, the moveable shell has a curve approximately identical to the curve of the fixed shell. According to a further embodiment, the moveable shell has two protuberances in the form of bands.

Moreover, it is also possible to provide for the closing device to be formed from a single piece. According to one embodiment, the fixed shell is made in one sheet of the packaging.

According to one embodiment, the moveable shell is made in one sheet of the packaging.

According to yet another embodiment, it comprises two sheets, the fixed shell being integral with one face of a first sheet and the moveable shell is integral with one face of a second sheet.

Provision can also be made for the pivots to be parallel.

It is also preferable for the moveable shell to have two equilibrium positions, and for the developed length of the fixed shell to be comprised between D and π*D/2, and preferably between \sqrt{65}*D/8 and π*D/2, D being the distance between the pivots.

It is desirable for the distance between the pivots to be comprised between 2 mm and the width of the packaging, and preferably between 5 and 50 mm.

According to one embodiment, the pivots are provided by the assembly of the packaging sheets.

According to another embodiment, the pivots are provided by the closing device itself.

According to yet another embodiment, the pivots are “V” shaped. The shells also preferably have the following characteristics, with H being the thickness in mm, b the height in mm and E the equivalent modulus of a shell in N.mm⁻²:

for the fixed shell: the product bH³E is comprised between 50 and 5,000,000 N.mm⁻²;

for the moveable shell: the product bH³E is comprised between 5 and 200,000 N.mm⁻².

Moreover, it is desirable for the shells to have the following characteristics, with H being the thickness in mm, b the height in mm and E the equivalent modulus of a shell in N.mm⁻²:

for the fixed shell: the product bH³E is comprised between 200 and 500,000 N.mm⁻²;

for the moveable shell: the product bH³E is comprised between 35 and 50,000 N.mm².

Moreover, the shells advantageously have the following characteristics, with H being the thickness in mm, b the height in mm and E the equivalent modulus of a shell in N.mm⁻²:

the ratio between the products bH³E respectively of the moveable shell and the fixed shell is comprised between 1:1000 and 1:1. According to one embodiment, the articulation of the moveable shell is provided by one sheet of the packaging.

According to a further embodiment, the moveable shell is formed from a piece comprising a flexible part articulating the rigid parts. According to another embodiment, the closing device moreover has a tight and tear-off cap, stopping the flow between the fixed shell and the moveable shell.

The invention also relates to a production method for a packaging according to the invention, comprising the following stages:

the assembly of a first and second sheet, leaving an opening;

the rendering integral with one of the two sheets at the level of the opening, of an added fixed shell.

The invention also relates to another method, comprising the following stages:

the assembly of a first and second sheet, leaving an opening;

the rendering integral with one of the two sheets at the level of the opening, of an added moveable shell.

According to one embodiment, the assembly is carried out by welding. According to another embodiment, the assembly is carried out by gluing.

Moreover, it is also possible to provide a previous extrusion or injection stage of a shell.

According to one embodiment, the fixed shell is made concave after having been rendered integral with one of the two sheets.

The invention also relates to a production method comprising the following stages:

the assembly of a first and second sheet, leaving an opening;

the provision of a concave fixed shell;

the flattening by elastic deformation of the fixed shell;

the affixing of the fixed shell to one sheet of the packaging.

According to another method, the following stages are carried out:

the assembly of a first and a second sheet, leaving an opening;

the affixing of the closing device to the first and to the second sheet.

According to another method, the following stages are carried out:

the assembly of a first and a second sheet in which the fixed shell is produced, leaving an opening;

the affixing of a moveable shell to the first sheet.

The invention also relates to a method for opening or closing a packaging according to the invention, comprising a stage of application of a force to the flexion inversion means according to an action line not passing by one of the pivots.

The invention is now described in more detail in the following description, and with reference to the drawings, in which:

FIG. 1 represents diagrammatically and in perspective, a packaging and an open closing device according to a first embodiment of the invention;

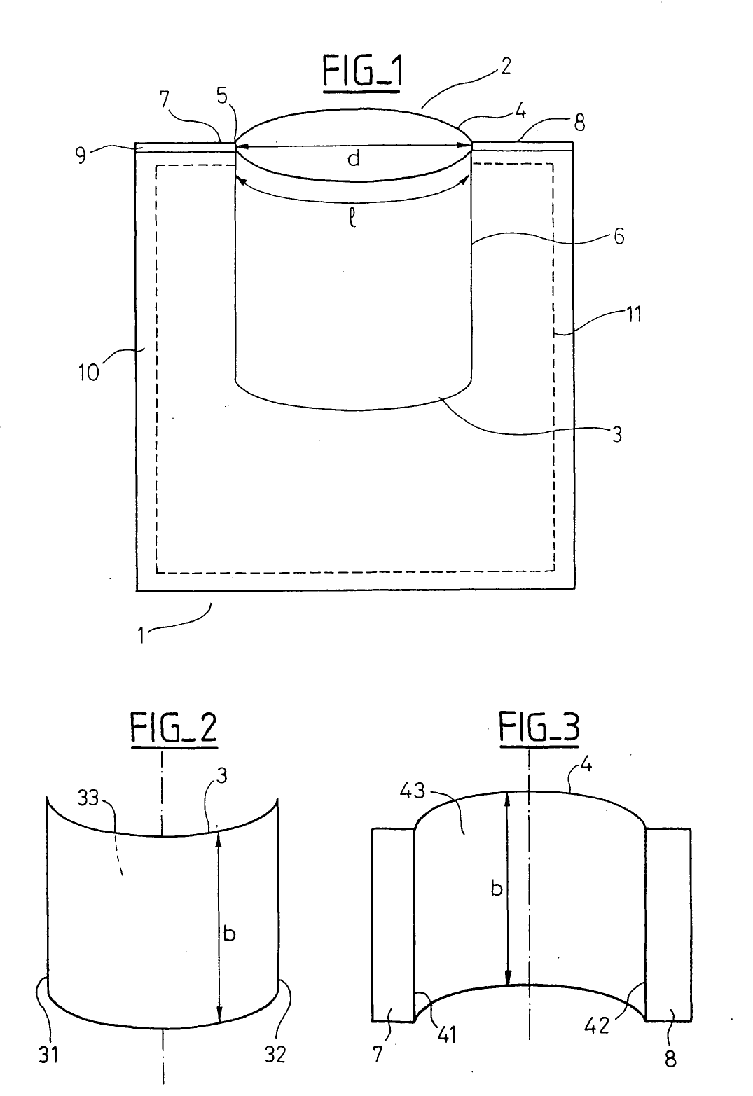

FIG. 2 represents diagrammatically and in perspective, a fixed shell of a closing device according to FIG. 1;

FIG. 3 represents diagrammatically and in perspective, a moveable shell of a closing device according to FIG. 1;

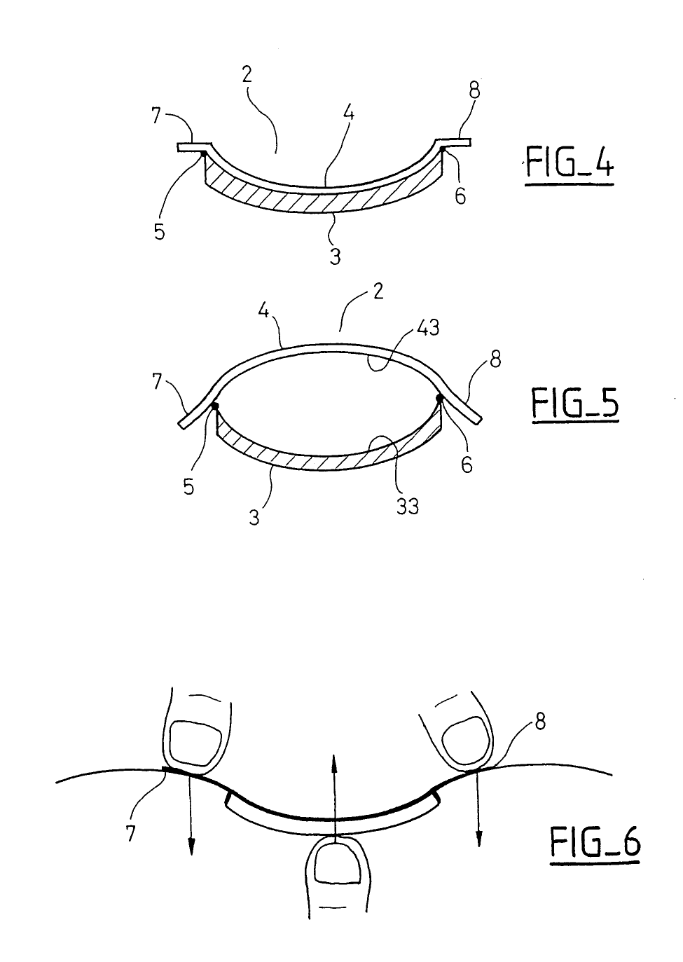

FIG. 4 represents the closing device of FIG. 1, closed in cross section, following a normal plane at its axis;

FIG. 5 represents the closing device of FIG. 1, open in cross section, following a normal plane at its axis;

FIG. 6 represents diagrammatically the forces applied by an operator in order to open the closing device of FIG. 1;

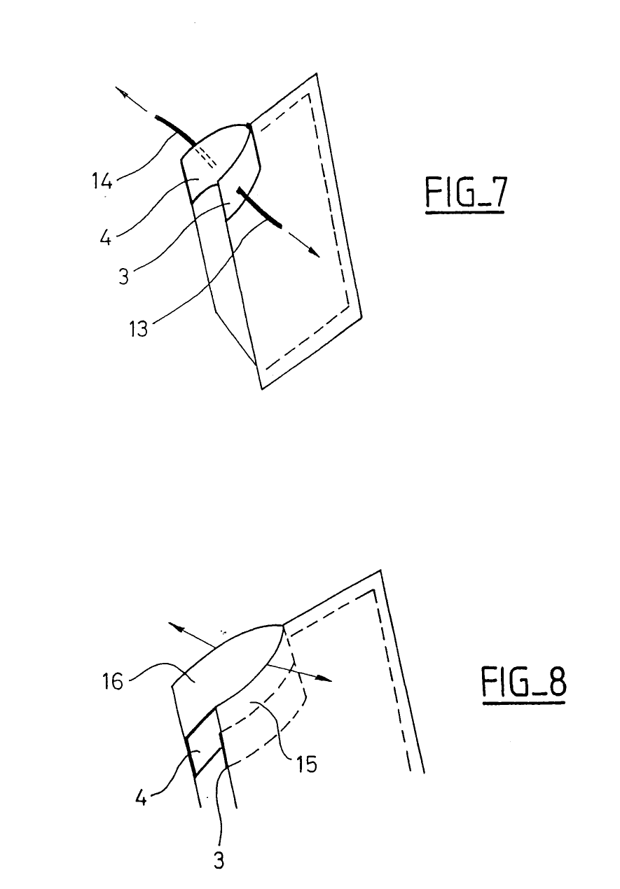

FIG. 7 represents in cross-section, a packaging according to one embodiment of the invention;

FIG. 8 represents in cross-section, a packaging according to another embodiment of the invention;

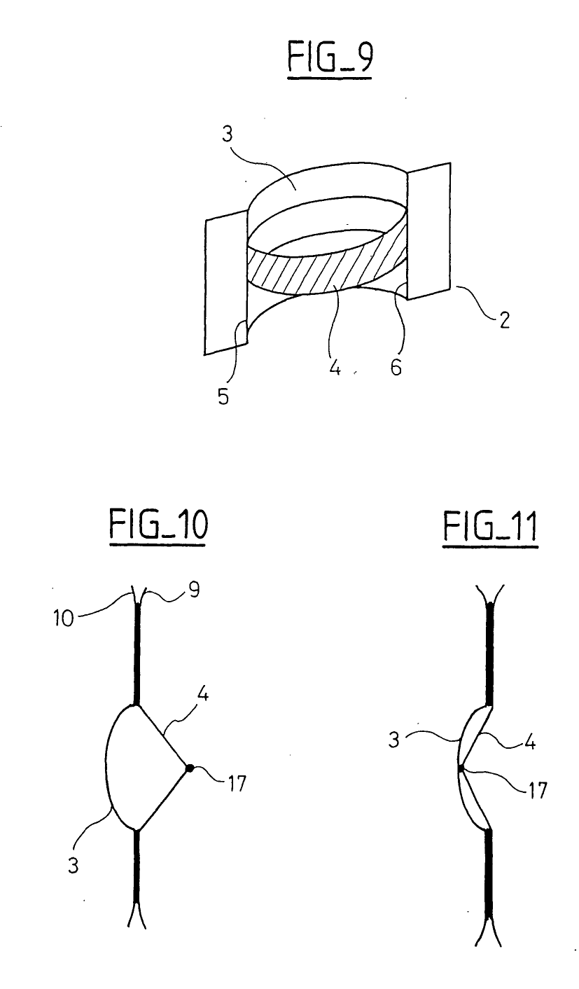

FIG. 9 represents the closing device of a packaging according to another embodiment of the invention;

FIGS. 10 and 11 represent a top view of a packaging according to yet another embodiment of the invention;

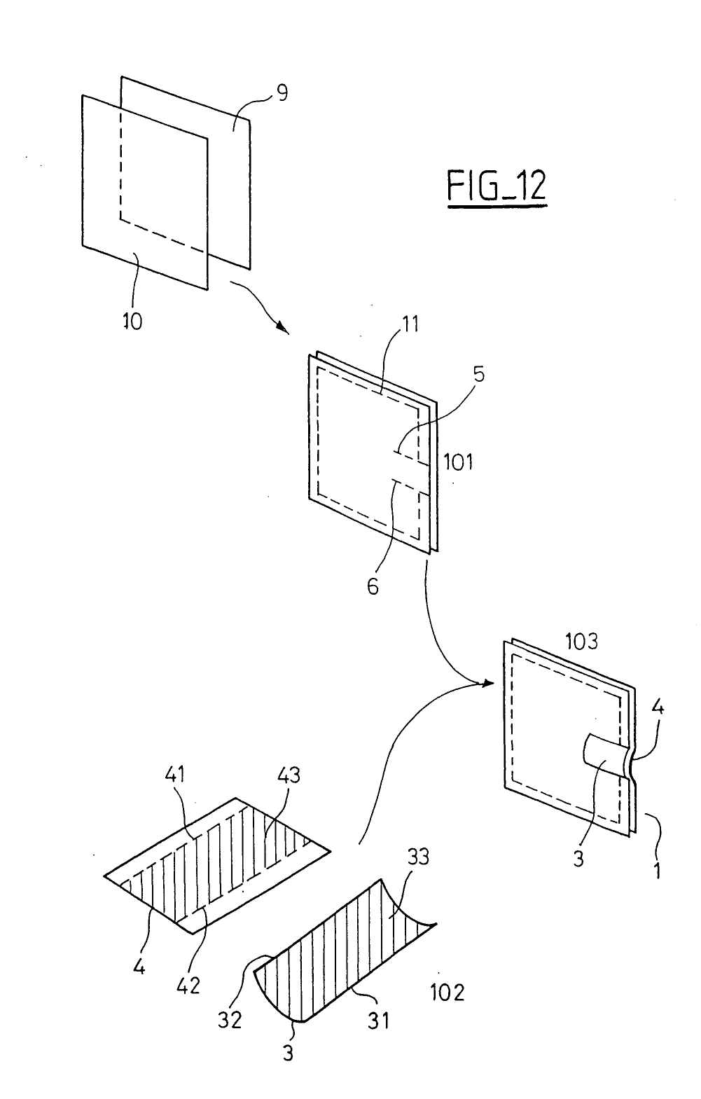

FIG. 12 represents the stages of a production method for a packaging according to the invention.

The invention provides a packaging with closing device, said closing device having a moveable shell the flexing states of which define the opening and closing positions of the closing device, the moveable shell having flexion inversion means. Such a closing device can for example be obtained by forming pivots between this moveable shell and a concave fixed shell, and by providing this moveable shell with flexion inversion means.

FIG. 1 shows a packaging 1 according to a first embodiment of the invention, having a closing device 2. In this embodiment, the moveable shell has a rigidity less than the rigidity of the fixed shell. The closing device 2 comprises a concave fixed shell 3 facing a moveable shell 4. The moveable shell is articulated following two parallel pivots 5 and 6 on the fixed shell. The moveable shell, according to an embodiment described hereafter, advantageously has two actuating protuberances 7 and 8 extending beyond the pivots. The packaging also comprises two sheets 9 and 10, facing each other, assembled to form a reservoir. These sheets are assembled in a tight fashion at their periphery by a weld 11.

These sheets are made up of material standard in the art, in particular of plastic material such as PET, OPA, OPP, PA, PE, PP or also aluminium paper etc. These sheets can be used in a single layer or in a multilayer structure, combined or coextruded for example. These two sheets are in particular semi-rigid, in the sense that they can be deformed in order to accept the expansion of the sachet, while providing general stability of the sachet. The thickness of these two sheets is standard in the art, for example a thickness comprised between 30 and 1000 μm, and preferably between 60 and 250 μm.

The packaging has an overall thickness generally less than 2 mm, preferably below 500 μm.

These packagings are appropriate in all the technical fields, in particular those of food, chemicals, detergents, cosmetics; for liquids, powders, granules or small solids (for example sweets), and even gases.

FIGS. 2 and 3 represent in perspective, the shells 3 and 4 of the closing device 2 of FIG. 1. The shell 3 is a fixed and concave shell, having two edges 31 and 32 and a closing face 33. The concave shell 3 can be obtained from an angular cylinder section, or by shaping from a plane shape for example. The shell 4 is a flexible and moveable shell, initially concave under the effect of the pivots and of the fixed shell; in fact the developed length between pivots 1 of the moveable shell is greater than the distance d between articulations. The shell 4 has two edges 41 and 42. The shell 4 has a moveable closing face 43, intended to come into contact with or to move away from the face 33. The closing faces 33 and 43 advantageously have the same curve, as once the moveable shell 4 is in contact with the fixed shell, it adopts the curve of the latter. The edges 41 and 42 are articulated respectively to the edges 31 and 32, forming the pivots 5 and 6 represented in FIG. 1. The pivots 5 and 6 represented are parallel but they could also be arranged in a “V”. Thus, it is easier to flex the shell 4. The shell 4 also advantageously comprises two protuberances 7 and 8 projecting with respect to the closing face 43, from the edges 41 and 42 respectively. These protuberances are made in the continuation of the closing face 43. Thus, the application of a force, the line of action of which does not pass by the pivots 5 and 6, to one of the protuberances 7 or 8, modifies the curve of the closing face 43 of the moveable shell 4. These protuberances are preferably band-shaped and can also provide a consistent useful surface, and can easily be made during the formation of the shell 4. The protuberances could simply be lugs, protruding beyond the pivots. The flexion inversion means could also be presented otherwise than in the form of these protuberances but be presented in the form of extensions or strips which can be manipulated by the user, as described hereafter.

FIGS. 4 and 5 represent a cross-section following a section normal to an axis of the shells, the closing device 1 being in the closed and open position respectively.

In FIG. 4, the closing device is seen in the closed position. The moveable shell 4 is then flexed in a first stable position. In this position, the closing face 43 of the moveable shell is held up against (it “fits”) the closing face 33 of the fixed shell and thus stops the passage through the opening of the packaging, the content of which is gaseous, liquid or solid. The edges 41 and 42 of the moveable shell are articulated following two pivots 5 and 6 at the edges 31 and 32 of the fixed shell respectively. The rigidity of the fixed shell 3 makes it possible to keep the edges 41 and 42 at a distance smaller than the length of the material of the moveable shell which joins them.

In FIG. 5, the closing device is seen in the open position. The moveable shell is then flexed into a second stable position. In this position, the closing face 43 of the moveable shell is separated from the closing face 33 of the fixed shell and thus frees the passage through the opening of the packaging. The rigidity of the shell 2 makes it possible to keep the edges 41 and 42 at a distance smaller than the length of the material of the moveable shell which joins them. Thus, the moveable shell is forced into the stable opening position. The shell 4 is then in a second stable position, in which its curve is inverted with respect to the closed position.

As represented in FIG. 6, the passage from one position to the other can be obtained preferably by flexion inversion means arranged on the moveable shell. In the embodiment presented, these means correspond to the protuberances 7 and 8, extending laterally from the edges 41 and 42 of the moveable shell 4. By exerting the forces represented by the arrows in the figure on the protuberances, the position of the moveable shell can be modified until the moveable shell reaches a stable open position. Thus, the application of forces on the protuberances 7 or 8, the line of action of which does not pass by the pivots 5 or 6, whilst holding the fixed shell in place, for example in its centre as represented by the arrow attached thereto, shifts the closing face from its stable closed position. By continuing the application of these forces, the moveable shell reaches a transition position. Beyond this position, the moveable shell will naturally flex in order to occupy a stable open position.

It is also possible to use flexion inversion means other than the protuberances 7 and 8. According to the embodiment of the packaging represented in cross-section in FIG. 7, strips 13 and 14 are respectively integral with the shells 3 and 4. These strips can for example be welded or glued to the shells or to zones of the sheets 9 and 10 integral with the shells. It is sufficient to exert a force on the strips, as represented by the arrows, in order to open the closing device. These strips are preferably placed at the level of the median part of the shells.

FIG. 8 shows another embodiment of flexion inversion means. Parts 15 and 16 made in the sheets 10 and 9 respectively project with respect to the shells of the closing device. Thus, it is sufficient to exert a force on the parts 15 and 16 in order to open the closing device.

The passage from one stable position to the other can also be obtained by pressing the faces 33 and 43 of the shells one against the other, for closing. For opening, it is sufficient to separate these same faces, by introducing for example an object between these faces, such as a straw.

The pivots 5 and 6 are preferably flexible in order to allow relative pivoting of the edges 31 and 32 with respect to the edges 41 and 42 respectively. This join can be made by means of a glued joint or a welding of the shells at this level. The join can also be made by affixing the shells 2 and 3 respectively to two faces of a packaging, assembled one against the other in order to form the pivots between the shells. Methods for producing the packaging are described in detail hereafter. The pivots can have, at the level of their weld, a “V” shape.

According to another embodiment of the invention, the closing device is made in one piece and comprises a moveable shell and a fixed shell. Thus, the moveable shell and the fixed shell are made in a single piece. Such a piece can in particular be obtained by moulding or by extrusion.

FIG. 9 represents an example of a closing device according to this embodiment of a packaging. This closing device comprises a fixed shell 3 and a moveable shell 4 formed in a single piece. It is thus possible to obtain a closing device in a single piece. The fixed shell and the moveable shell can pivot one with respect to the other about pivots 5 and 6. The fixed shell has an upper band and a lower band surrounding a band forming the moveable shell. When the closing device is in the closed position, the moveable shell is wedged between the upper part and the lower part of the fixed shell. The fixed shell and the moveable shell can thus be shifted one with respect to the other without covering each other. When the fixed shell has a number of bands greater than that of the moveable shell, the fixed shell has a greater rigidity than the moveable shell. A first sheet is rendered integral with the rear part (represented by hatching in the figure) of the moveable shell 4. A second sheet is rendered integral with the rear part of the fixed shell 3. The closing device is thus placed inside the packaging. The closing device is represented in the open position in FIG. 9; the moveable shell is in fact separated from the fixed shell. In order to close the closing device, it is sufficient to press the moveable shell in the direction of the fixed shell. When the moveable shell is wedged between the two parts of the fixed shell, the sheets solidly affixed respectively to the moveable shell and to the fixed shell come into contact in order to prevent any flow of fluid. Such a closing device can be obtained from a plate in which two longitudinal cuts are made to delimit the moveable shell and the fixed shell. The shells can then be made concave, by moulding for example.

The closing device and the embodiment represented in FIG. 9 is formed in a single piece, but it is also possible to envisage making this closing device in the form of several independent moveable and fixed shells. It is also possible to envisage the moveable shell or the fixed shell having a different number of parts. The closing device represented in FIG. 9 also has protuberances 7 and 8, but other flexion inversion means of the moveable part can also be used, such as those represented in FIGS. 7 and 8.

FIGS. 10 and 11 represent a top view of another embodiment of a packaging according to the invention. In this embodiment, the moveable shell comprises two articulated parts. The moveable shell preferably has an articulation 17 substantially towards its middle. In this embodiment, the fixed shell is preferably flexible and the two parts are preferably rigid. The moveable shell can thus be folded back against the fixed shell in order to close the closing device. When a user moves the flexible shell towards the moveable shell from the open position of the closing device, the pivots are moved apart. The two parts of the moveable shell pivot about the articulation, and the fixed shell flexes in order to allow the pivots to move apart. The moveable shell and the fixed shell are respectively integral with the sheets 9 and 10. The articulation can be made in the shell itself or by means of the sheet 9.

A moveable shell with a rigidity greater than a value Rmin is preferably used. Thus, the moveable shell only has a few stable flexing positions. The moveable shell then has a tendency return by itself towards one of the closing or opening positions when it is removed from one of the latter. Moreover, it can then exert a closing pressure on the closing face 33, ensuring good tightness of the closing device. Moreover, a moveable shell is preferably used, with rigidity smaller than a value Rmax. Thus, the moveable shell flexes easily when it is stressed by a user. The open position of the closing device then has an optimum passage section, and the closing position of the closing device is moreover suitably tight. The rigidity of a moveable shell is also determined as a function of the size of the closing surface 43.

The moveable shell can be made with a material having an equivalent bending modulus E comprised between 700 and 5000 Mpa. An average thickness H comprised between 8 μm and 1 mm is suitable. A moveable shell is preferably used with a thickness H comprised between 50 and 500 μm. A shell height b comprised between 1 and 50 mm is suitable. A shell height b comprised between 3 and 20 mm is preferably used for the moveable shell. A product bH³E, characterizing rigidity, comprised between Rmin=5 N.mm² and Rmax=200,000 N.mm² for the moveable shell is suitable. A moveable shell having a product bH³E comprised between 35 and 50,000 N.mm² is preferably used.

It is desirable to choose a rigidity for the shell 3 that is greater than the lower limit of rigidity R′min in order to have a shell which deforms slightly when manipulated by a user. A substantially constant distance can thus be maintained between the pivots.

The fixed shell can thus be made with a material having an equivalent bending modulus E comprised between 700 and 5000 Mpa. An average thickness H comprised between 20 μm and 2 mm is suitable. A fixed shell is preferably used with a thickness H comprised between 100 and 1000 μm. A good compromise is thus obtained between the rigidity and the compactness of the shell. A shell height b comprised between 1 and 70 mm is suitable. A shell height b comprised between 3 and 30 mm is preferably used for the moveable shell. A product bH³E, comprised between 50 and 5,000,000 N.mm² for the fixed shell is suitable. A shell having a product bH³E comprised between 200 and 500,000 N.mm² is preferably used.

It is however preferable for the product bH³E of the moveable shell to be below or equal to that of the fixed shell. Thus a ratio R between the rigidities comprised between 1:1000 and 1:1 will preferably be chosen. The fixed shell will only flex fairly slightly in this case, during the deformation of the moveable shell.

It is preferable for the distance D between the pivots 5 and 6 to be comprised between 2 mm and the width of the packaging, and more particularly between 5 and 50 mm.

Generally, it is preferably to use a fixed shell and a moveable shell, the developed lengths of which between pivots are similar. Thus a ratio of the developed length of the moveable shell to the developed length of the fixed shell comprised between 0.9 and 1.1 will preferably be chosen.

With the distance between articulations designated d, moreover a developed length between pivots comprised between D and π*D/2, and more particularly between \sqrt{65}*D/8 and π*D/2, is chosen. The moveable shell can then have two stable positions: a stable position on either side of the plane defined by the pivots. Thus, when the two shells are on the same side of this plane, the closing device is closed. When the shells are on either side of this plane, the closing device is open.

Materials such as PE, PVC, PMMA, EVA, PP, OPP, PET, polycarbonate, PA, cardboard, steel or aluminium can be used to make the shells. The shells can be presented in the form of single- or multi-layer films, or injection-moulded pieces. They can for example be obtained by stamping, heat forming, injection or thermoforming.

A person skilled in the art can, depending on the values of b, D, H, E, H3E and R, define the appropriate materials and thicknesses.

Finally it will be noted that the sheets and films can comprise the standard additives, and be made up of several layers, as is known in the art. Thus, the films or sheets can comprise several layers, one of which can be welded.

According to one embodiment of the invention, one of the sheets of the packaging is attached to the fixed shell and acts as moveable shell.

According to a further embodiment of the invention, the moveable shell is taken back over one sheet of the packaging.

It is also possible to make the packaging and the closing device in a single piece. It is also possible to make the closing device and one of the shells in a single piece.

This closing device can also comprise additional tightness devices such as those known in the state of the art, to produce perfect tightness.

Thus, according to another embodiment, a tear-off cap is arranged on the end of the closing device. This cap can make it possible to ensure perfect tightness of the closing device before use of the packaging. This cap can also ensure that the packaging is tamper-proof and secure. This cap can be made for example by welding of the sheets of the packaging above the closing device. This tear-off cap can for example make it possible to maintain a packaging which is sterile or under vacuum before being opened by a user. This cap can also comprise a peel-off film, which can preferably be repositioned.

The invention also relates to production processes of a packaging 1.

FIG. 12 represents the stages of a production method for a packaging according to the invention. This method comprises Stage 101, which consists of assembling two sheets 9 and 10, by superposing them and making a weld 11. This weld 11 leaves an opening in the packaging. The weld 11 defines two pivots 5 and 6 at the level of the opening.

Moreover, in Stage 102, a plane moveable shell 4 is glued, at least on its closing face 43 and a fixed concave shell 3 is glued on its closing face 33. In this stage it is possible to delimit the edges 41 and 42 by only gluing the closing face 43.

In Stage 103, the shells are fixed on the outside faces of the assembled sheets. The glued closing face 33 of the fixed shell 3 is applied to the sheet 10 at the level of the opening. The edges 31 and 32 are placed in correspondence with the weld pivots 5 and 6. The closing face 43 of the moveable sheet 4 is also applied to the sheet 9 at the level of the opening. The edges 41 and 42 are placed in correspondence with the weld pivots 5 and 6. The closing faces can be pressed one against the other in order to improve the adhesion and give a concave shape to the moveable shell 4 with a curve identical to the curve of the concave fixed shell 3. Another method makes it possible to place the shells inside the packaging. For this purpose, the faces opposite the closing faces 33 and 43 of the shells 3 and 4 are glued. As in the previous method, it is possible to delimit the edges 41 and 42 by gluing only the face opposite the closing face 43. The shells are then fixed on the inside faces of the assembled sheets.

According to another method, a first and a second sheet are assembled, leaving an opening, then a concave fixed shell is added. The concave shell is then flattened elastically, then assembled at the level of the opening on one of the two sheets. The fixed shell then returns to its original concave position.

According to another production method for a packaging according to the invention, a plane fixed shell is joined to, or formed in one sheet of the packaging, then concave according to a known method.

It is also possible to envisage carrying out the assembly of the shells on the sheets by welding. It is also possible to assemble the sheets by gluing.

The production can moreover make use of a screen-film which allows welding of one of the sheets to the other, leaving an opening at the level of the closing device. A film forming a screen is introduced onto a sheet at the level of the opening to be left. The other sheet is then rendered integral with the previous structure, and the whole is placed between two jaws of a welding machine or welding bars. This film forming a screen is made from a material which is more-or-less insensitive to heat and which does not adhere to the film at the welding temperature. It can for example be made from PTFE, or another material, such as Teflon-coated fabric. In this case the sheets and the fixed shell, or the sheets and the fixed and moveable shells can be welded at the same time.

It will be noted that the above processes are used without major modification in the case of one of the sheets of the packaging serving as moveable shell.

The invention is not limited to the embodiment represented, but is capable of a number of improvements easily accessible to a person skilled in the art. Thus, a packaging having a closing device, the only stable position of which is in the closed position remains within the scope of the invention. Moreover, although the concave shells have chiefly been described with a continuous curved shape, a shell having a discontinuous shape, such as a “V” shape, remains within the scope of the invention.

1. Packaging (1), comprising a closing device (2), said closing device comprising a fixed shell (3) and a moveable shell (4) articulated to said fixed shell via pivots (5, 6), said moveable shell having flexion inversion means (7, 8) formed by at least one protuberance (7, 8) of the moveable shell beyond a pivot.

2. The packaging of claim 1, characterized in that the moveable shell comprises two articulated rigid parts and in that the fixed part is flexible.

3. The packaging of claim 1 or 2, characterized in that the fixed shell and the moveable shell are placed facing each other.

4. The packaging of claim 1 or 2, characterized in that the fixed shell and the moveable shell each have a closing face, these closing faces being displaced.

5. The packaging of one of the previous claims, characterized in that the fixed shell (3) is concave.

6. The packaging of claim 5, characterized in that the fixed shell is curved.

7. The packaging of claim 6, characterized in that the fixed shell is formed from an angular cylinder sector.

8. The packaging of claim 6 or 7, characterized in that the moveable shell has a curve approximately identical to the curve of the fixed shell.

9. The packaging of one of the previous claims, characterized in that the moveable shell has two protuberances (7, 8) in the form of bands.

10. The packaging of one of the previous claims, characterized in that the closing device is formed from a single piece.

11. The packaging of one of the previous claims, characterized in that the fixed shell (3) is made in one sheet of the packaging (9, 10).

12. The packaging of one of the previous claims, characterized in that the moveable shell (4) is made in one sheet of the packaging (9, 10).

13. The packaging of one of claims 1 to 10, characterized in that it comprises two sheets, the fixed shell being integral with one face of a first sheet and in that the moveable shell is integral with one face of a second sheet.

14. The packaging of one of the previous claims, characterized in that the pivots (5, 6) are parallel.

15. The packaging of claim 14, characterized in that the moveable shell has two equilibrium positions and in that the developed length of the fixed shell is comprised between D and π*D/2, and preferably between \sqrt{65}*D/8 and π*D/2, D being the distance between the pivots (5, 6).

16. The packaging of claim 10 or 11, characterized in that the distance between the pivots is comprised between 2 mm and the width of the packaging, and preferably between 5 and 50 mm.

17. The packaging of one of the previous claims, characterized in that the pivots are provided by the assembly of sheets of the packaging.

18. The packaging of one of claims 1 to 12, characterized in that the pivots are provided by the closing device itself.

19. The packaging of one of the previous claims, characterized in that the pivots are in the shape of a “V”.

20. The packaging of one of claims 1 or 3 to 19, characterized in that the shells have the following characteristics, with H being the thickness in mm, b the height in mm and E the equivalent modulus of a shell in N.mm⁻²:
for the fixed shell: the product bH³E is comprised between 50 and 5,000,000 N.mm ⁻²; and preferably between 200 and 500,000 N.mm⁻²;
for the moveable shell: the product bH³E is comprised between 5 and 200,000 N.mm⁻², and preferably between 35 and 50,000 N.mm⁻²;

21. The packaging of one of claims 1 or 3 to 20, characterized in that the shells have the following characteristics: with H being the thickness in mm, b the height in mm and E the equivalent modulus of a shell in N.mm⁻²:
the ratio between the products bH³E respectively of the moveable shell and the fixed shell is comprised between 1:1000 and 1:1.

22. The packaging of claim 2, characterized in that the articulation of the moveable shell is provided by one sheet of the packaging.

23. The packaging of claim 2, characterized in that the moveable shell is formed from a piece comprising a flexible part articulating the rigid parts.

24. The packaging of one of the previous claims, characterized in that the closing device moreover has a tight and tear-off cap, stopping the flow between the fixed shell and the moveable shell.

25. Production method for a packaging according to one of claims 1 to 9 or 12 to 24, comprising the following stages:
the assembly of a first and second sheet, leaving an opening;
the rendering integral with one of the two sheets at the level of the opening, of a separate fixed shell.

26. Production method for a packaging according to one of claims 1 to 9 or 12 to 24, comprising the following stages:
the assembly of a first and second sheet, leaving an opening;
the rendering integral with one of the two sheets at the level of the opening, of a separate moveable shell.

27. The production method for a packaging according to claim 24 or 25, characterized in that the assembly is carried out by welding.

28. The production method for a packaging according to claim 24 or 25, characterized in that the assembly is carried out by gluing.

29. The production method for a packaging according to one of claims 25 to 28, characterized in that it moreover comprises a previous extrusion or injection stage of a shell.

30. The production method for a packaging according to one of claims 25 to 29, characterized in that the fixed shell is made concave after having been rendered integral with one of the two sheets.

31. Production method for a packaging according to one of claims 1 to 9 or 12 to 24, comprising the following stages:
the assembly of a first and a second sheet, leaving an opening;
the provision of a concave fixed shell;
the flattening by elastic deformation of the fixed shell;
the affixing of the fixed shell to one sheet of the packaging.

32. Production method for a packaging according to claim 10, comprising the following stages:
the assembly of a first and a second sheet, leaving an opening;
the affixing of the closing device to the first and to the second sheet.

33. Production method for a packaging according to claim 10, comprising the following stages:
the assembly of a first and a second sheet, in which the fixed shell is made, leaving an opening;
the affixing of a moveable shell to the first sheet.

34. Method for opening and closing a packaging according to one of claims 1 to 23, comprising a stage of application of a force to the flexion inversion means, according to a line of action not passing by one of the pivots.
